(19) United States
(12) Patent Application Publication
(10) Pub. No.: US 2012/0022713 A1
(43) Pub. Date: Jan. 26, 2012

(54) Power Flow Simulation System, Method and Device

(76) Inventors: Brian J. Deaver, SR., Fallston, MD (US); Parag A. Parikh, Germantown, MD (US)

(21) Appl. No.: 13/005,410

(22) Filed: Jan. 12, 2011

Related U.S. Application Data
(60) Provisional application No. 61/294,921, filed on Jan. 14, 2010.
(60) Provisional application No. 61/295,887, filed on Jan. 18, 2010.

(51) Int. Cl. G06F 1/28; G06G 7/63

(52) U.S. Cl. 700/298; 703/18

(57) ABSTRACT

Embodiments of the present invention provide power flow analysis and may process electrical power distribution system data in real time to calculate load, current, voltage, losses, fault current and other data. The power flow analysis system may include a detailed data model of the electrical power distribution system, and may accept a variety of real time measurement inputs to support its modeling calculations. The power flow analysis system may calculate data of each of the three distribution system power phases independently and include a distribution state estimation module which allows it to incorporate a variety of real time measurements with varying degrees of accuracy, reliability and latency.

### CROSS REFERENCE TO RELATED APPLICATIONS

This application claims priority to U.S. Provisional Application No. 61/294,921, filed Jan. 14, 2010 and to U.S. Provisional Application No. 61/295,887, filed Jan. 18, 2010, which are both incorporated herein by reference in their entirety for all purposes.

### FIELD OF THE INVENTION

The present invention generally relates to systems, methods and devices for simulating power flow, and more particularly for monitoring, modeling and controlling power flow in a power distribution network.

### BACKGROUND OF THE INVENTION

The power system infrastructure includes power lines, transformers and other devices for power generation, power transmission, and power distribution. A power source generates power, which is transmitted along high voltage (HV) power lines for long distances. Typical voltages found on HV transmission lines range from 69 kilovolts (kV) to in excess of 800 kV. The power signals are stepped down to medium voltage (MV) power signals at regional substation transformers, and distributed to corresponding regions. MV power lines carry power signals through neighborhoods and populated areas, and may be overhead power lines or underground power lines. Typical voltages found on MV power lines power range from above 1000 V to about 35 kV. The power is stepped down further to low voltage (LV) levels at distribution transformers. LV power lines typically carry power having a voltage ranging from about 100 V to about 600 V to customer premises.

The infrastructure for conducting power from its source of generation along high voltage power lines to one or more regional substations is referred to as a power transmission system. The infrastructure for moving electricity from a regional substation along MV power lines and LV power lines to homes, buildings and other points of consumption is referred to as a power distribution system. The various power transmissions systems and power distribution systems form the power grid. To better manage and maintain power transmission systems and power distribution systems, it is desirable to simulate power flow in order to predict voltage, current and fault current measurements at specific locations on the power grid in real time. However, power distribution systems are very large and can have very complex geometries. As a result, there have been challenges in creating effective power distribution modeling solutions which operate in real time.

Accordingly, there is a need for systems and methods for monitoring, and simulating power flow in real time which provide accurate and reliable results for power distribution systems. More specifically, there is a need to know, in advance, the impact of making changes to the power distribution system configuration, such as changes to device settings, reconfiguration of network, and adding or removing devices and loads.

Further, as the demand for power increases, the size of power distribution systems increases, and the power grid becomes more complex, there is a need to better manage and control the flow of power. In particular, there is a need to quickly and efficiently make changes to the power distribution system based on a power flow model that is based on real time data—instead of purely estimates or historic data—to satisfy specifications and/or regulations and to provide efficient power delivery. These and other needs may be addressed by various embodiments of the present invention.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities depicted in the drawings:

FIG. 1 is a diagram of a portion of a power distribution system for which power flow may be simulated in accordance with an example embodiment of the present invention;

FIG. 2 is a data and control flow diagram of a system for simulating power flow in a power distribution system, in accordance with an example embodiment of the present invention;

FIG. 3 is an example schematic diagram of a bus/breaker connectivity model for a balanced 2-bus-1-branch segment of a power distribution system;

FIG. 4 is a flow chart of a method for simulating power flow, in accordance with an example embodiment of the present invention;

FIG. 5 is a flow chart of another method for simulating power flow, in accordance with an example embodiment of the present invention;

FIG. 6 is a flow chart of a method for providing load balancing, in accordance with an e example embodiment of the present invention;

FIG. 7 is a flow chart of a method for improving the efficiency of a power distribution system, in accordance with an example embodiment of the present invention; and

FIG. 8 schematically illustrates a plurality of applications for implementing an example embodiment of the present invention.

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, operating systems, development interfaces, and hardware are omitted so as not to obscure the description of the present invention.

Some embodiments of the present invention provide power flow analysis software applications that operate on an electrical power distribution system in real time to calculate load, current, voltage, losses, fault current and other data. The power flow analysis software application may include a detailed data model of the electrical power distribution system, and may accept a variety of real time measurement inputs to support its modeling calculations. The power flow analysis software application may calculate data of each of the three distribution system power phases independently and include a distribution state estimation module which allows it to incorporate a variety of real time measurements with varying degrees of accuracy, reliability and latency.

According to an embodiment of the present invention, a system, method and device are provided for simulating power flow in a power distribution system. The power distribution system includes one or more medium voltage power line circuits along with various subnets coupled to such MV power line circuit. The MV power line circuit, comprised of one or more (typically up to three in the U.S.) MV power line phase conductors, may receive power from one or more power substations, and may include various utility network elements for maintaining and controlling power distribution.

Electrical behavior and responses for the utility network elements (UNE) and various segments of the power distribution system may be simulated by the present invention using a detailed model and computational techniques. Users may define various simulation parameters to interactively ascertain equipment loadings, voltages, currents, and electrical losses for selected portions of the power distribution system.

Of particular significance is that the power flow simulation system, method and device may use real time measurement data from portions of the power distribution system being modeled. In particular, the power distribution system may be populated with sensors for monitoring voltage, current and/or other power distribution parameters (volt-amperes reactance or VARs). Such measurement data may be collected and transmitted to an operations or processing center, such as by a power line communication system, wireless network, wired network, or any combination of the same. In some embodiments a conventional supervisory control and data acquisition (SCADA) system located at a power substation also may collect data which may be transmitted to the operations or processing center.

The availability of such real time data enables the invention to perform not just planning of the construction of the infrastructure, but also provide real time power distribution system performance monitoring and control. Accordingly, before reconfiguring a UNE device (e.g., a switch, capacitor bank, transformer load tap setting, voltage regulator setting, recloser, circuit breaker, etc.), power flow—the voltage, the current, the VARs at a plurality of locations of the power grid (e.g., locations on an MV circuit)—may be simulated for the new configuration. Further, a configuration to be simulated may be provided by a user who provides a set of user input parameters via a user interface or from another software application designed to improve network conditions such as by reducing VARs and/or regulating voltage. Accordingly, the simulator serves to ensure that actions to be taken do not lead to overload, over-voltage or under-voltage conditions and well as determine the configuration(s) that will provide the desired resulting condition (e.g., reduced power consumption, reduced VARs, reduced losses, etc.).

Power Distribution System

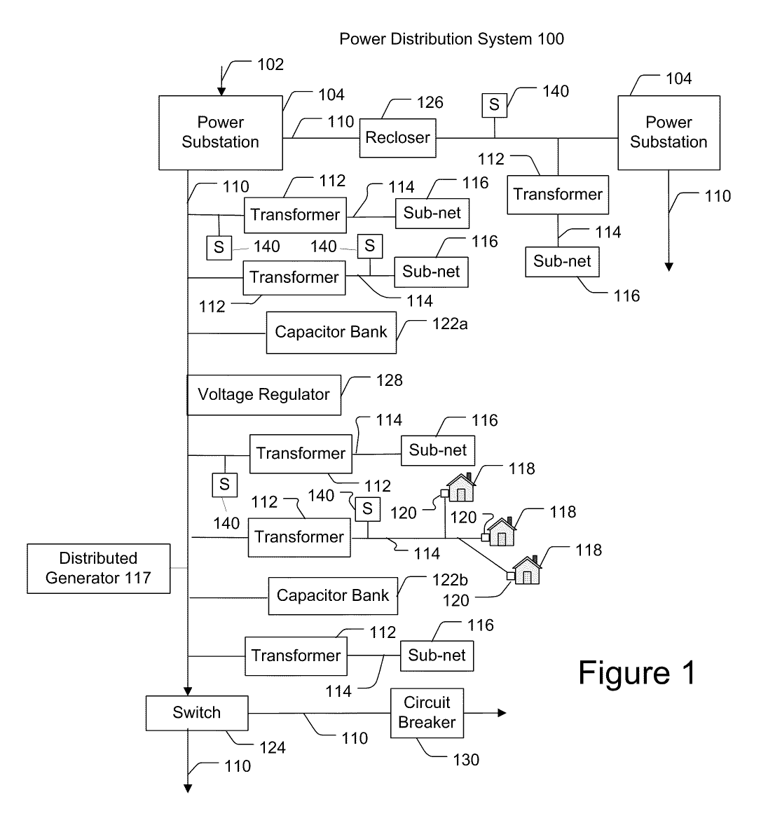

FIG. 1 depicts a portion of a power distribution system 100 that comprises an MV circuit including various utility network elements (UNE), power lines, sensors and subnets. As described in the background section, power is stepped down from high voltage (HV) to medium voltage (MV) power at regional substation transformers, and then distributed to corresponding regions. For example, a HV power line 102 may feed into a power substation 104, where a transformer (not shown) steps down the voltage to medium voltage. MV power lines 110 carry MV power through neighborhoods and populated areas, and may comprise overhead power lines and/or underground power lines.

Various UNE devices and power lines form part of the power distribution system 100. For example, various distribution transformers 112 may be coupled to a MV power line 110 and step down the voltage to low voltage (LV) power carried by a LV power line 114 that each serves an LV subnet 116. An LV subnet 116, as used herein, refers to the LV power lines 114 and the one or more utility customer premises 118 connected to the LV power lines 114. Typically, a utility meter 120 at the customer premises measures the power consumption of each customer premises 118.

Other UNE devices may include capacitor banks 122, switches 124, reclosers 126, distributed generation 117, dispatchable loads, load tap changer, voltage regulators 128 and circuit breakers 130. A switch 124 may be included to control the flow of power through an MV circuit. Switches also may be beneficial for load shedding and prioritization of circuits. A recloser 126 is a circuit breaker equipped with a mechanism that can automatically closes the breaker after it has been opened, such as in response to a fault. Reclosers are typically used in coordinated protection schemes for overhead power line distribution circuits. A voltage regulator 128 serves to maintain the output voltage within a given voltage range. For example, under changing load conditions, the voltage regulator attempts to maintain a desired voltage while current increases or decreases according to the change in power. Control messages transmitted to a voltage regulator 128 may be used to control the voltage output of the voltage regulator 128. A circuit breaker 130 is an automatically-operated switch designed to protect a circuit from damage caused by overload or short circuit. The basic function of a circuit breaker is to detect a fault condition and, by breaking the connection, immediately discontinue power flow. A load tap changer (not shown) typically is used to control the voltage output from the substation transformer. Distributed generator 117 refers to a source of electrical power that may regularly or occasionally supply power to the power distribution network 100 such as, for example, from a windmill, solar panels, or an industrial plant. Distributed generators 117 may be connected to an MV power 110 (as shown) or an LV power line 114.

To monitor and maintain the power distribution system 100 various ancillary systems may receive power distribution system data. To obtain such data, various sensors 140 may be located throughout the power distribution system 100. A sensor 140 may measure voltage, current, VARs, power factor, and/or other power distribution parameters. The sensors 140 may be coupled to an MV power line 110, or an LV power line 114 as a stand alone device, or may form part of (or be co-located with) a UNE device (e.g., a capacitor bank may include sensors). Sensors 140 may form part of a plurality of electric utility meters 120 to provide data of the power delivered to a customer premises (including power, voltage, current, VARs, power factor, etc.). Further, in some embodiments a computer system may be located at a power substation 102 and gather data. For example, data may be collected via a SCADA system, which obtains analog measurements and that monitors device status and device settings. Data may also be collected via an outage management system (OMS), automated meter reading system (i.e., AMI collected data), and from a Geographic Information System (GIS), which may provide data related to the as-built layout of the power distribution system network. The collected data may be processed locally or transmitted to a remote computer system for processing. For example, some UNE devices such as capacitor banks 122 may process voltage and current data to determine power factor and/or VARs.

In some embodiments, a power line communication system may be installed and operated at the power distribution system 100 to collect and transmit data to the remote computer system. An example of a power line communication system is described in U.S. application Ser. No. 10/641,689, entitled “Power Line Communication System and Method of Operating the Same,” filed Aug. 14, 2003, issued as U.S. Pat. No. 6,980,091, which is hereby incorporated by reference in its entirety for all purposes. Alternatively, or in addition data may be transmitted via a wired or wireless network, such as by broadband cable, wireless cellular (e.g., a mobile telephone network), a pager system, the internet and/or other wide area network.

### Power Flow Simulator

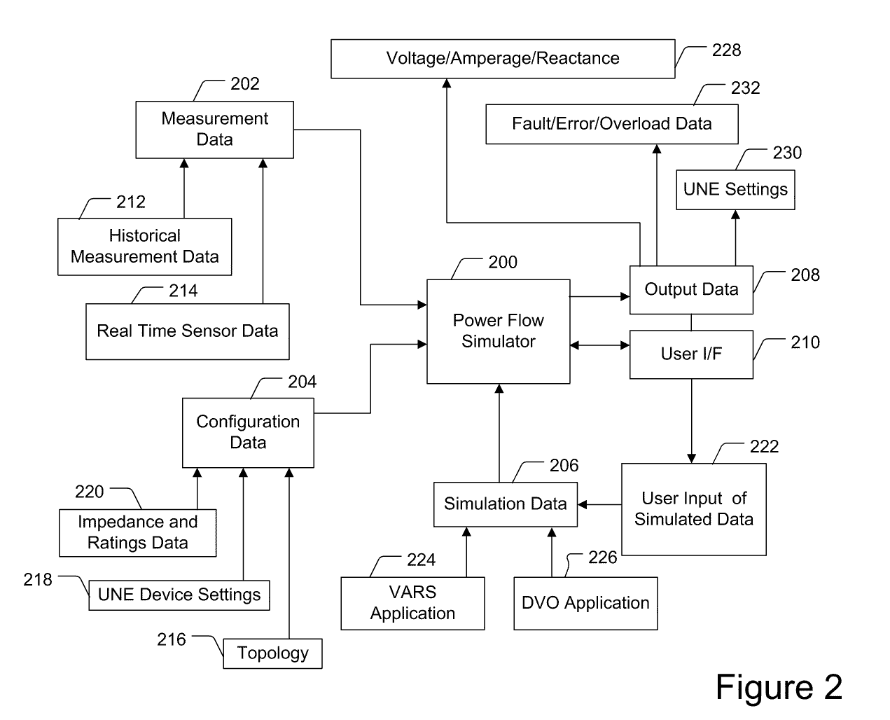

FIG. 2 is an illustration of a data and control flow for a power flow simulator 200. The power flow simulator 200 may be embodied as a computer system (which may be distributed) executing a software application, including executable program code and data. The simulator 200 processes measurement data 202, configuration data 204 and simulated data 206 to generate output data 208. Various databases may be accessed to obtain data to be processed. A user interface 210 may be included to allow a user to define various simulation parameters, to setup and execute various simulations, and to view, store and/or otherwise input/output various simulation results.

In an example embodiment, the power flow simulator 200 may be one of a plurality of utility processing center applications used for monitoring and maintaining a power utility network. For example, other applications may serve to collect data from the field in real time for use by the simulator 200 in real time. Further, other applications may provide simulated data pertaining to various UNE devices and network segments. Still further, the outputs of the power flow simulator 200 may be used by other applications to reconfigure a portion of the power distribution system 100, such as by an application that sends commands to change the settings of one or more utility network elements.

Measurement data 202 may comprise data of the measured voltage, current, VARs, power factor, apparent power, real power, and/or other data. As will be evident to those skilled in the art, some such data (e.g., power factor) is derived from actual measurements of the voltage and current. Typically, such derivation is performed (often automatically) by the sensor 140 and is therefore considered measurement data herein. The measurement data 202 may be real time sensor data 214 for one or more UNE devices and/or power distribution system locations or historical data 212. Real time data, as used herein, refers to data from measurements taken with in the last thirty minutes, more preferably within the last fifteen minutes, still more preferably within the last ten minutes, yet more preferably within the last five minutes, and most preferably within the last minute. So the processing of real time measurement data by the simulator 200 refers to the processing of data from measurements taken at least within the most recent thirty minutes from all or a subset of the plurality of sensors 140. In some systems, data from some sensors may be more recent (e.g., within the last five minutes) than other data (e.g., within the last ten to fifteen minutes), but all such data would be considered real time measurement data. Some embodiments may require all real-time data to be from measurements within the most recent fifteen minutes. The measurement data may be obtained via a SCADA system, a plurality line communication system, and/or other suitable method and may include actual measurement data received from sensors 140 at all or a subset of the plurality of utility meters 120, capacitor banks 122, transformers 112, reclosers 126, distributed generator 117, switches 124, circuit breakers 130, dispatchable loads (e.g., at a consumer or commercial customer), load tap changers (or other voltage regulating device) at the substations 104, voltage regulators 128, and/or other UNE devices.

Configuration data 204 may include topology data 216, UNE device settings data 218, and UNE impedance and ratings data 220. The power distribution system may be modeled as a plurality of nodes. The topology of the power distribution system may be defined as the interconnection of the various nodes. Each node may correspond to one (or more) UNE devices, or a junction of different power lines (e.g., where the size of a power line cable changes or at the juncture of multiple power lines such as at a branch or where a UNE is connected to a power line). Thus, the topology data 216 comprises data that may specify the connectivity of the various power distribution system infrastructure (e.g., nodes) such as, for example, UNE devices and power lines. The topology data 216 may include data of the (relative) locations of capacitor banks, switches, reclosers, voltage regulators, load tap changers, circuit breakers, transformers, meters, (virtual) nodes and other UNE devices. In order to support the real-time topology processing, the simulator may add virtual nodes in topology to identify location of power sources, network boundary and load points. The virtual node placement algorithm may utilize GIS provided data to create the virtual nodes. In some embodiments or scenarios, sensors 140 may not be present at all desired locations and the voltage, current, VARs, power factor and/or other parameters may be computed based on the data that is available from sensors located elsewhere (e.g., on either side of the location) and/or historical data. State estimation may reduce the number of required sensors on the power distribution system.

The UNE device settings data 218 comprises data of the configuration settings for a given device. For example, a capacitor bank 122 may be engaged or not engaged (i.e., switched in or out) or, in some capacitor banks a capacitance setting may be employed. A switch 124 may be closed or open. A voltage regulator 128 may have various voltage output settings. A substation transformer may have various load tap changer settings to provide various voltage outputs. A circuit breaker may be open or closed. The UNE device settings data 218 may be collected via any suitable method such as via a SCADA system. Such collected data comprises actual data as opposed to simulated UNE device settings data that may be supplied by the user or other application to allow the simulator 200 to simulate the power distribution system 100 with a potential change to one or more device settings.

The impedance and ratings data 220 may include standard ratings data for various UNE devices and data of power line conductor sizes, lengths and ratings. For example, a database may be maintained that includes the impedance and ratings for various models of various devices (e.g., capacitor banks, switches, reclosers, voltage regulators, load tap changers, circuit breakers, transformers, overhead conductors, underground cables etc.) at various device configuration settings under one or more conditions. In some embodiments the impedance and ratings data may be used to allow multiple UNE devices and/or power lines to be modeled as an equivalent electrical circuit. Such circuit then may be implemented as a single node in a simulation, rather than as the plurality of nodes for the UNEs and other components forming the circuit.

Simulated data 206 may include data of one or more “proposed” UNE configuration device settings and may be supplied from a user as a user input or as data from other software applications or computer systems. For example, simulated data 206 may comprise a contemplated configuration setting(s) of one or more capacitor banks, switches, load tap changers, dispatchable loads, distributed generators, voltage regulators, and/or other UNE devices. Simulated data may be supplied from one or more other software applications (executing on the same or a different (potentially remote) computer system) such as a volt amp reactance (VAR) application 224 that is designed to reduce VARs and/or to maintain a power factor value range at various locations across the power distribution system. As another example, simulated data may additionally (or alternately) be supplied by a dynamic voltage optimization (DVO) application 226 that is designed to conserve power by regulating the voltage supplied to power customers (typically by reducing delivered voltage to a level marginally above regulatory requirements). An example of such an application that uses real time data to provide conservation voltage reduction is described in U.S. application Ser. No. 12/424,322, published as U.S. Publ. No. 2009/0265042, filed Apr. 15, 2009, which is hereby incorporated by reference in its entirety for all purposes. An example of such an application that uses performs volt-VAR management is described in U.S. application Ser. No. 12/590,604, filed Jan. 20, 2010, which is hereby incorporated by reference in its entirety for all purposes. Thus, simulated data may be used in place of available actual data to provide a simulation of the power distribution system with the proposed changes identified by the simulated data.

As an example and referring to FIG. 1, a segment of an MV power line 110 may have two capacitor banks 122a and 122b, which are presently switched out. A software application (or a user) may supply the power flow simulator 200 with simulated data that includes data representing capacitor bank 122a in a “switched in” configuration. The simulator 200 may then process the actual real time measurement data 202, the configuration data 204 of the network, with the simulated data 206 of capacitor bank 122a in a switched in configuration (instead of using the actual configuration data of capacitor bank 122a in the switched out configuration) to produce an output 208. Based on the output 208, the software application (or the user) supplying the simulated data or another application may elect to switch in the capacitor bank 122a, do nothing, or run another simulation with different simulated data (e.g., in which capacitor bank 122b is switched in instead or in addition thereto).

In addition, the simulated data may comprise a desired voltage for a location of a medium voltage power line, desired voltage output for one or more distribution transformers 112, desired voltages for power lines at one or more utility meters 120, or some quantity of distribution generated power. Thus, the desired power distribution system parameter(s) may be supplied as simulated data and the power flow simulator 200 may be configured to “work backwards” (e.g., by running multiple simulations) to determine the device configuration settings of the UNE devices of the power distribution system 100 that will result in the power distribution system 100 having parameters that most closely match the simulated parameter(s). As an example, a user may wish to determine the configuration of all of the UNE devices so that the delivered voltages to one or more power customers 118 (as measured at the meters 120 or distribution transformer 112 outputs) is within a predetermined range and the VARs at one or more locations are the lowest. Alternately, the user may wish to determine the configuration of all of the UNEs that results in the lowest power supplied (from a substation) or, alternately, lowest power consumed by power customers in the aggregate (with delivered voltages within regulatory ranges).

In addition, simulated data may include configuration data (e.g., device settings data) and topology data (e.g., where located) for UNE devices that are actually (yet). For example, when a hypothetical device or segment is to be included in a simulation of the power distribution system 100, the user (or application) may supply simulated data 222 identifying the type of device and its proposed location on the power grid. Impedance and ratings data and/or device setting options may be accessed from a database (e.g., 220) or supplied by the user or application for the proposed device or segment.

The power flow simulator 200 generates output data 208 by processing the various inputs. Depending on the input, the output data 208 may include voltage, amperage, VAR data 228, and UNE settings 230 (as well as associated location information for each value) as well as available fault current, power losses, error, and/or overload data 232 for various segments (e.g., locations) of the power distribution system 100. For example, voltage and amperage may be specified for each node (i.e., for each UNE and power line juncture) and at various locations along a given MV power line 110, LV power line 114, and/or at one or more customer premises 118. Load values may be determined in kilowatts (KW) and kilo-VAR for each load (e.g., power customer). In addition, VARs may be determined at each node. UNE device configuration settings 230 may be determined for any one or more UNE devices such as where the simulation parameters allow for changes in UNE configuration settings, (e.g., to determine a voltage set point, for dispatching dispatchable loads; for avoiding a fault, error and/or overload condition). For example, capacitor settings may be output to obtain a desired voltage and/or VARs for one or more capacitors (as well as associated location information or other identifying information for each capacitor). Transformer tap settings may be determined to obtain desired (e.g., regulated) substation output voltages. Available fault current, power losses, error and overload data 232 may be identified (including locations thereof). For example, a transformer (including its location) that would be overloaded under a particular simulated configuration may be identified. The available fault current for a zero impedance fault may be quantified for one or more locations. The power losses in the circuit may be summed. A power line voltage, current or other power distribution parameter that is out of threshold and/or at risk for a fault (e.g., causing a fault or failing) may be identified (including locations determined for all identified). The identity and location of jeopardized components also may be specified for such fault. Other adverse conditions and errors also may be identified.

Power Distribution System Model

The power flow simulator 200 creates a virtual model of the power distribution system 100 based upon the actual data (configuration data 204 and measurement data 202) and simulated data 206. In some instances the model corresponds entirely to an actual and potential configuration of all existing UNE devices, power lines and LV subnets of the power distribution system 100. In other instances the model also may include other UNE devices, power lines or LV subnets not yet installed but that are being proposed by the utility. In still other instances, the model may omit some actual UNEs components while including some non-existing “hypothetical” UNEs (e.g., for load balancing determinations) that are proposed.

The power flow simulator 200 models the power distribution system 100 based on a given data set. More specifically, the power flow simulator 200 determines the electrical behavior of the utility network elements (UNE), power lines, LV subnets and various segments in response to the supplied measurement data 202, configuration data 204 and simulated data 206. The data set may be existing data of the network including data of measured voltages, measured currents, capacitor configurations, voltage regulator settings, substation transformer LTC (load tap changer) settings, switch configurations, distributed generator outputs, dispatchable load configurations, recloser configurations and other data and may include computed data of such parameters such as, for example, VARs, voltages, currents, etc. at locations where measurements are not available.

In one embodiment the power flow simulator provides a full, unbalanced solution with individual modeling of each MV phase. For example, it may support a four-wire model of electrical behavior that does not make any assumption about symmetry or balance. The power flow simulator 200 may provide various functions, including solving power flow for both mesh network and radial feeders; calculating fault levels for each node for single phase, two phase and three phase faults; and monitoring voltage and flow violation against a user specified set of limits. Line impedances may be calculated using Carson's equations. The power flow simulator 200 also may calculate loads to match telemetered (measured) or forecasted feeder current. Further, voltage regulator output, the number of energized capacitors within a capacitor bank and regulation control status (whether the voltage regulator is in automatic or manual control and/or other control parameters) may be determined by the simulator 200. In addition, electrical losses may be calculated in KW for all modeled UNE devices and customer loads (or LV subnets).

In an example embodiment, the Power Flow simulator 200 implements a nodal admittance matrix analysis where the phase bus voltages (and automatic taps settings and switched capacitor settings) are determined. A “bus” as used herein is synonymous with a “node” as discussed above. For example, a Ybus Gauss-Seidel method may be implemented to solve for voltages and phase angles, transformer tap ratios and capacitor status (engaged or not engaged) for a given set of transformer loads and distributed generations. Individual phase (i.e., a power line conductor where multiple conductors are present carrying different phases of power such as in three phase power delivery) voltages may be treated as independent variables. The Ybus Gauss-Seidel method provides effective convergence properties for a highly radial network with high R/X ratios (resistance versus reactance of conductors), such as may be found in distribution feeder (i.e., MV power line) networks. The Ybus Gauss-Seidel method may be implemented by solving for complex bus (i.e., node) voltages using an inverted bus admittance matrix. An advanced sparse lower triangulation matrix—upper triangulation matrix (LU) factorization algorithm may be used to efficiently solve the equations.

[V]=[Y]⁻¹[I], Equation 1

Where,
V is the vector of complex bus voltages;
Y is the bus admittance matrix in complex form; and
I is the node current injection (in complex form) calculated from the net power injection at each node.

In some instances, the current injections may not be among the input data, (i.e., measurement data, configuration data, simulated data) and therefore may need to be computed from other input data. As an example, a constant power load may be converted into a current injection by assuming or computing a voltage value. Equation 1 may be solved iteratively. The transformation from constant power to constant current may be adjusted for each iteration until convergence. When all loads are constant impedance loads, the equation may be solved in a single iteration.

It is possible that inaccurate measurement data may prevent Equation 1 from converging. To avoid such an outcome, bad measurement values may be identified by comparing actual real time measurement data against statistical data and historical data. The power flow simulator 200 also may check Q (VAR) to P (real power or watts) scaling factor to verify that the ratio is not too large. For example, if load power factor significantly exceeds a reasonably expected value, then Q measurement for scaling may be ignored. Similarly if the ratio of preset load P and scaled value is too large, then P scaling may be avoided.

The power flow simulator 200 also may be used to specify load shedding to shed one or more dispatchable loads. For example, the configuration data 204 may include identification of dispatchable loads (e.g., within an LV subnet) for which load shedding may be implemented. Given current actual measurement data, power distribution network performance may be simulated for various load shedding configurations to determine an effective load shedding operation to be performed. As a result of the output, a control message to be transmitted to the identified load control devices to dispatch the identified loads.

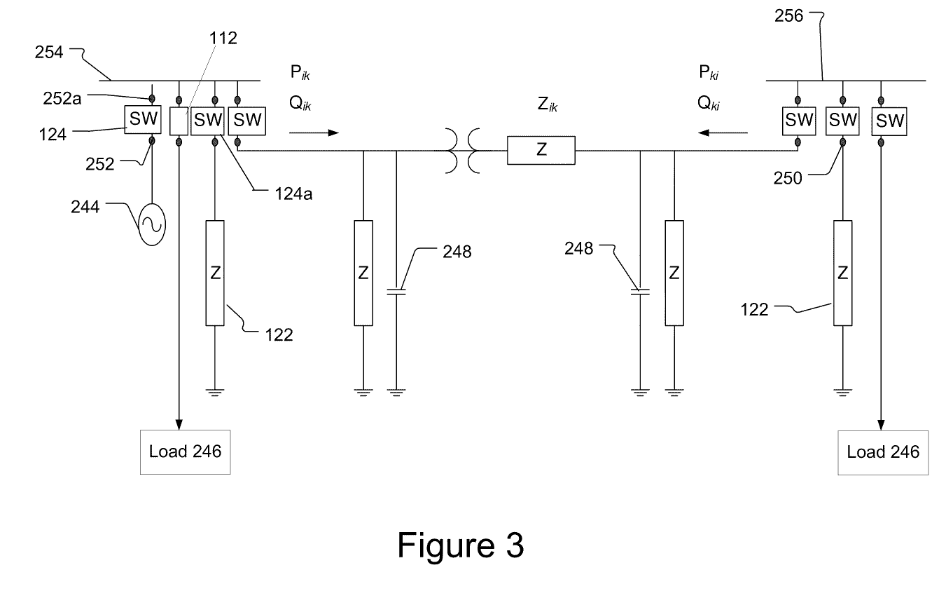

FIG. 3 depicts an example model output of an example portion of a power distribution system that may be generated by the power flow simulator 200. FIG. 3 depicts an example bus/breaker connectivity model for a balanced 2-bus-1-branch subsystem portion of the power distribution system 100. Branch components, such as power lines, transformers, or series-devices (zero-impedance branches or series reactive devices) have two terminals, and are normally connected between two electric nodes. The transformer 112 depicted in FIG. 3 may be a simple fixed-ratio transformer. In another embodiment the transformer 112 may be a Load-Tap-Changing transformer where either the primary side winding, or the secondary side windings has taps that could be used to adjust the corresponding side voltage within a range of its nominal value. In still another embodiment the transformer 112 may be a phase-shifter which is essentially a transformer that could be inserted in series with a branch (mostly an AC power line), to create a controllable phase angle/shift from either end of the branch to the other end, and control the flow of kW/Amps on such branch.

Shunt components, such as generators 244, loads 246, capacitors 248 and reactors have one terminal each. Switches 124 (which could alternately be a fuse, circuit breaker, contactor, recloser, etc.) have two terminals, and are normally connected between two electric terminals 252. Switching devices generally have only two states: either open or closed: a closed switching device represents a perfect connection between its two terminals, and an open switching device represents no connection between its two terminals.

Each utility network element (that is not a switching device) is often connected through one of its terminals 252 to a power line via a switching device 124a (e.g., a fuse). The upstream electric terminal 252a from a switch 124 also may be connected to a corresponding bus 254. In a single-phase equivalent 2-bus-1-branch subsystem depicted in FIG. 3, Bus 254 hosts a generator 244, a load 246, and a capacitor bank 122 (modeled as shunt impedance), and connects through a branch ik (that could be a MV power line, LV power line, a transformer, or a series device) to Bus 256, which in turns hosts another load 246 and a capacitor bank 122 via switches. Parameter data (voltage, current, VARs, etc) may also be output for each node as part of the simulation and may include some data that is from measurements, some data that is computed by the power flow application 200, and some data that is simulated (i.e., supplied to the power flow application 200).

Utility network elements can also be designated as removed, and can be represented as disconnected from the electric network, without the modeling of any switching device status changes. This allows for the modeling of power distribution outages, even when explicit switching devices have not been modeled at the component terminals.

For an overhead or underground power line, self and mutual series impedance matrices may be generated using the modified Carson's equations for un-transposed distribution lines. Shunt admittance matrices also may be generated.

Power Flow Simulation Methods

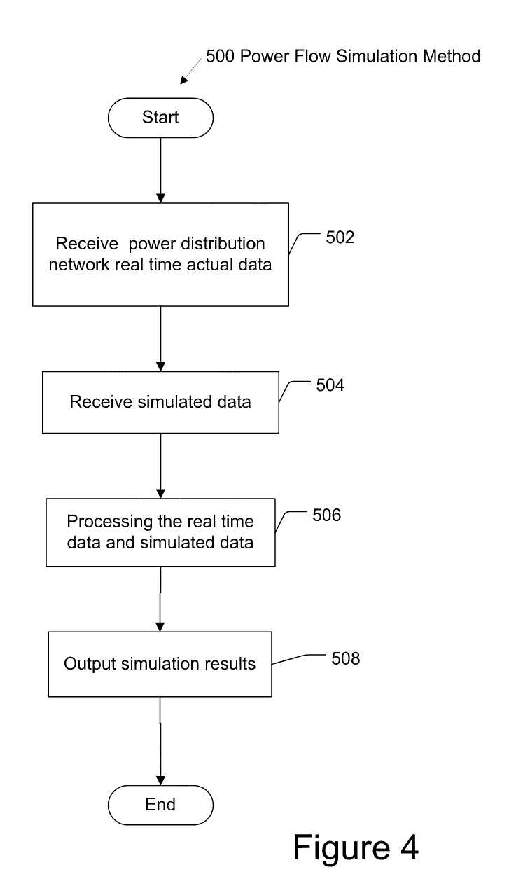

FIG. 4 depicts a power flow simulation method 500 in accordance with an example embodiment of the present invention. At 502 actual data is received in real time to the computer system. The actual data may include measurement data 202 (e.g., current, voltage, VARs, power factor, etc.) and configuration data 204 (e.g., UNE device settings data 218, impedance/ratings data 220, and topology data 216) for a power distribution system 100 or a portion thereof. For example, actual data may be received for a power distribution system having a plurality of distribution transformers, one or more medium voltage (MV) power lines, capacitor banks, substation voltage regulating devices (e.g., substation transformer load tap changer), reclosers, circuit breakers, and/or switches. A plurality of measurement devices (e.g., sensors) and utility monitoring and control systems (e.g., SCADA systems) may be used to obtain the actual data. For example, measurements may be received from one or more sensors 140 measuring MV power line and LV power line power parameters (e.g., at utility meters 120). The actual data also may include configuration data of the device settings of the capacitor bank(s), switch(es), voltage regulator(s) and other devices.

At 504 simulated data may be accessed, obtained or otherwise received. For example, user inputs may be received which define UNE device settings or desired power flow parameters for a power flow simulation. In another example, data from a VAR application and/or data from a dynamic voltage optimization (DVO) application may be received. It is worth noting that the order of such processes 502 and 504 may vary.

At 506 the actual data and simulated data may be processed to generate output data that includes the voltage, current, VARs, power factor, and/or other parameters at a plurality (or all) of the nodes of the modeled circuit. The output data may also include identification of any faults, errors, overloads, or other adverse conditions. If computing the UNE device configuration settings for desired power parameters, the output data also may include UNE device settings that are to be implemented in order to obtain the desired parameters (e.g., VARs, voltages, current, etc.). At 508 the output data may be output for multiple nodes of the model and correspondingly for various locations of the power distribution system 100. In other embodiments, another process may include transmitting control messages to implement a simulated configuration if the output data satisfies predetermined conditions (e.g., reduced power consumption, reduced losses, monetary savings (as determined by M&V application), etc.).

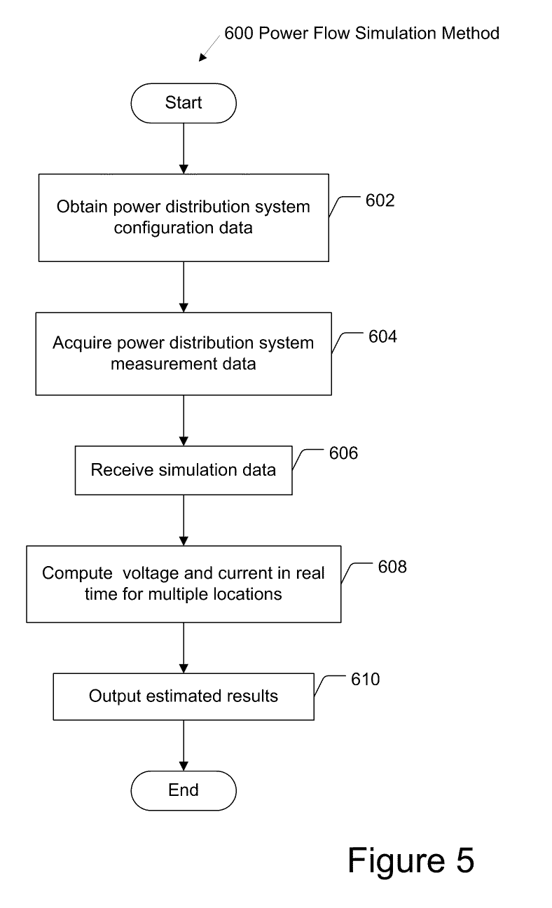

FIG. 5 depicts a specific power flow simulation method 600 in accordance with an example embodiment of the present invention. At 602 power distribution system configuration data is obtained including, for example, topology data, UNE device setting data, and UNE device ratings data. For example, the topology data, impedance data, and ratings data may be stored at local and/or remote databases and be accessed to obtain the desired data. The UNE device settings also may be obtained by accessing databases. A SCADA system may store such settings data or such data may be obtained via other means.

At 604 measurement data for the power distribution system may be acquired. For example, real time actual measurement data may be obtained from the plurality of sensors 140 including sensors at one or more utility meters 120. Other measurement data also may be obtained such as from a SCADA system or other utility monitoring and control system linked, coupled or otherwise capable of accessing the power distribution system. Further, for some simulations historical actual data (actual data previously acquired) of the power distribution system also may be included among the measurement data. Simulations executed using historical data may be used to determine if alternate UNE device configurations would have resulted in improved power distribution system performance (e.g., lower VAR, lower distribution losses, lower power consumption, etc.). Thus, multiple simulations may be executed using historical data to determine which configuration would have resulted in the most desirable power distribution profile. Thus, the power flow application 200 may operate in various modes including using real time data to predict the result of a proposed configuration under present conditions or using historical data to predict the result of an alternate configuration under past conditions. Historical data also may be used to determine one or more sets of configuration settings data for one or more UNE devices that would have resulted in a desired or preferred power distribution profile (reduced power consumption, reduced losses, reduced VARs, etc.).

At 606 simulated data may be received, such as simulated UNE device configuration setting data and/or desired parameter data, from a user or other software application.

At 608 the configuration data, measurement data and simulated data is processed using a load flow analysis algorithm to compute the voltage and current for multiple power distribution network locations, (e.g., simulation model nodes). VARs also may be computed. At 610 the results are output. The output data may include the loads on any of one or more transformers. If computing the UNE device configuration settings for desired power parameters, the output data also may include UNE device settings that are to be implemented in order to obtain the desired parameters (e.g., power consumption, loss, VARs, lowest power supplied by substations, voltages, current, etc.). As a result of the output, a control message to be transmitted to one or more UNE devices identified by the power flow application to change the settings of devices in accordance with the model that provides the desired power distribution profile (e.g., power consumption, loss, VARs, lowest power supplied by substations, voltages, current, etc.).

In some embodiments, various output parameters such as the computed voltages, amperages and VARs may be compared with threshold data. When the simulation determines that the parameters are beyond a threshold (e.g., under a minimum threshold or over a maximum threshold), an alert may be output to specify the overload, fault or other adverse condition. Accordingly, the output data also may include any indications of overload conditions, faults or adverse conductions that may result for the given set of input data, and the locations (and/or associated UNE devices) of each.

The power flow simulation methods 500 or 600 may be implemented as a method for managing a power distribution network that includes a plurality of distribution transformers connected to one or more medium voltage (MV) power lines and a plurality of switches which control the flow of power over the MV power lines. Topology data corresponding to the interconnectivity of the infrastructure of the power distribution system may be stored in memory. Other configuration data also may be stored in memory, including data identifying the impedance, rating and type of network element (e.g., transformer, switch, etc.), data identifying the state of a device (e.g., respective states of a plurality of switches), and data characterizing the power lines (e.g., length and other characteristics). Real time data based on measurement of one or more power parameters taken at a group of the network elements may be received. The various input data may be processed to provide a first model that represents a first configuration of the distribution network in which the plurality of UNE devices such as switches, capacitor banks, voltage regulators, load tap changers, etc. are in a first state (e.g., corresponding to a first proposed configuration change). An input (from a user or other software application) may be received, and based on the input, the first model may be altered to provide a second model that represents a second configuration of the distribution network in which at least some of the UNE's are in a second (different) state. Additional simulations may be performed to provide a plurality of models with the multiple models being compared to each other determine which configuration results in power flow that most closely matches a desired power distribution profile (e.g., delivered voltage above a minimum and with the lowest power consumption, lowest power supplied by substations, lowest VARs, etc.). Further, in some embodiments one or more commands may be transmitted to one or more utility network elements to configure the power distribution network according to the configuration whose model most closely matches the desired power distribution profile.

The power flow simulator of one example embodiment simulates each of three phases independently and does not assume that they are all the same. The power flow simulator also considers the structure of lines (e.g., how spacing on utility poles changes the mutual impedance and, therefore changes the virtual model provided by the simulator).

The power flow simulator application of one example embodiment uses the Ybus Gauss-Seidel method to solve for the voltages and phase angles, transformer tap ratios and capacitor engagement statuses for a given set of transformer loads and distributed generators. In this example, the input data to the Power Flow Application (e.g., a state estimator of the application) may comprise:
1. A power system bus model. The bus model defines a set of nodes (i.e., the topology, etc.) and connected devices, including, for example:
   a. Power Lines
   b. Transformers
   c. Capacitors
   d. Power Sources (e.g., substation transformer)
   e. Distributed generators
   f. Dispatchable loads
   g. Switches
2. Power system component attributes;
3. Real-time measurement data at designated locations in the bus oriented network model;
4. Load interval meter readings from automated utility meters where available;
5. Substation data via SCADA or interval meter data where available;
6. Desired voltage set points for capacitor controlled buses (a “bus” as used herein is synonymous with a “node”);
7. Desired voltage setpoints for (e.g., substation) transformer controlled buses; and
8. Distributed generation (e.g., in megawatt (MW) and megaVAR (MVAR)).

Output data from the Power Flow Simulator Application may include:
1. Voltage magnitudes and phase angles for each node in the model;
2. Power flows in amps on each segment of conductor and each switch;
3. A list of overloaded lines/transformers;
4. Load values in kilowatts (KW) and kVar for each load;
5. If required, capacitor settings to obtain desired voltage profile;
6. If required, output voltage settings for each voltage regulator;
7. If required, switch settings for each switch; and
8. If required, transformer tap settings to obtained desired regulated bus voltages.

A discussed above, the Power Flow of this example is solved using the Ybus Gauss-Seidel algorithm where the sparse bus admittance matrix is used to iteratively solve for the bus (node) voltages. See Equation 1 above. For a three phase balanced formulation, the bus admittance matrix is formed from the impedances of the lines and transformers connected at each bus. The diagonal term for each bus may be calculated from:

Yᵢᵢ=Σ(G_{shunt,k}+jB_{shunt,k})+Σ((Gᵢⱼ+jBᵢⱼ)+jBch/2)

“Bch” is the line charging susceptance in per unit (p.u.) MVAR, which is often neglected for distribution lines but is included here for completeness. Note that capacitors and reactors can be explicitly represented in the bus admittance matrix or may also be modeled as MVAR injections. In this implementation, fixed capacitors (and other reactors) are embedded in the bus admittance matrix and variable capacitors are modeled as MVAR injections. The off-diagonal terms of the bus admittance matrix may be computed from:

Yᵢⱼ=−Σ(Gᵢⱼ+jBᵢⱼ)

In the case of a transformer the self and mutual admittance terms are modified by the tap ratio “a” as follows:

Yᵢᵢ=Σ(Gᵢⱼ+jBᵢⱼ)/aₜ² for the tap side

Yᵢⱼ=−Σ(Gᵢⱼ+jBᵢⱼ)/aₜ

The admittance terms are calculated from the impedances of the lines and transformers expressed in per unit as follows:

Gᵢⱼ=rᵢⱼ/(rᵢⱼ+Xᵢⱼ²)

Bᵢⱼ=−xᵢⱼ/(rᵢⱼ²+xᵢⱼ²)

The bus admittance matrix is formed as a sparse complex matrix, storing only the non-zero terms with the associated row column information. The matrix is symmetric and can be readily factorized into the form:

[Y]=[L][D][L]^{T}

The equations for the bus voltages may then be solved using forward and back substitution. For forward substition the nodes are processed in elimination order m:

uₙ=uₙ−ΣLₘₙ*/Dₘₘ*Iₘ
for n connected to m.

For back substitution the nodes are then processed in reverse elimination order:

Vₘ=Uₘ/Dₘₘ−ΣLₘₙ*/Dₘₘ*Vₙ

The substation bus (usually at the high side of the substation transformer), may be modeled as a source with a source impedance equal to the short circuit Thevenin equivalent impedance at the bus. The complex current injection at the source bus may be calculated from:

I_{source}=(V_{oc}+j0)*Y_{sc}

Where V_{oc} is the open circuit bus voltage magnitude in per unit;

And Y_{sc} is the Thevenin short circuit impedance at the source.

The source bus the diagonal term of the Ybus admittance matrix may be updated to include the Thevenin short circuit impedance.

At each iteration of the complex bus current injection may be calculated from the load or generation at each bus, by converting the injected real and reactive power to the corresponding complex current injection with the solved complex voltage. Loads may be modeled as Constant Power, Constant Current, Constant Impedance or as a composite of the above load types. The complex current injection for the constant power load may be calculated from:

I=((Pₙₑₜ+jQₙₑₜ)/(Vᵣ+jVᵢ))*

Where Pₙₑₜ, Qₙₑₜ are the net load injection into the bus and Vᵣ+jVᵢ is the complex solved voltage at the bus. In the case of constant power loads the current injection may be updated at each iteration with the latest solved complex voltage at each bus.

The complex current injection for the constant current load may be calculated from:

I=(((Pₙₑₜ+jQₙₑₜ)(|Vᵣ+jVᵢ|))/(Vᵣ+jVᵢ)*

Where Pₙₑₜ, Qₙₑₜ are the net load injection into the bus and Vᵣ+jVᵢ is the complex solved voltage at the bus. In the case of constant current loads the current injection may be updated at each iteration with the latest solved complex voltage at each bus.

The current injection for the constant impedance load is zero as the load is placed as an equivalent shunt impedance in the bus admittance matrix. The diagonal term of the shunt admittance matrix may be updated to include a term:

Y_{load}=P_{load}−jQ_{load}

In the case where all loads are constant impedance, then there is no need to iterate to obtain a solution as the bus current injection vector does not need to be updated.

Modeled transformer tap changers and voltage regulators may be automatically adjusted in solution to regulate a controlled bus voltage. The adjusted solved regulated bus voltage magnitude may be obtained from

V′_{regbus}=V_{bus}−IZ_{Idc}

Where V_{bus}=solved complex regulated bus voltage

I=((P+jQ)/V_{bus})*(solved complex current into the transformer in p.u.)

Z_{Idc}=r_{Idc}+jX_{Idc} the line drop compensation impedance.

The change in tap ratio is calculated from

Δa=Vₛₑₜₚₒᵢₙₜ−V′_{regbus}

In the case where there is no Line Drop Compensation resistance, the voltage used to calculate the change in tap setting is simply the solved bus voltage.

Switchable capacitors can be utilized as local controls to regulate the local bus voltage to a desired setpoint. Switchable capacitors may be modeled as a current injection at the capacitor bus so that the Y_{bus} matrix does not have to be updated with each change in MVAR injection. The required MVAR change at each iteration may be calculated using sensitivities derived from the factorized bus admittance matrix:

∂V/∂Q=[Y]⁻¹[ΔQ]

where [ΔQ]^{T}=[0 0 (0+j1) 0 . . . 0] where the non-zero entry corresponds to the capacitor bus. These sensitivities are obtained from a forward and back solution of the LU factorized Y_{bus} matrix.

The change in MVAR may then be calculated as:

ΔQ_{cap}=(Vₛₑₜₚₒᵢₙₜ−V_{bus})/(∂V/∂Q)

The capacitor MVAR is adjusted at each iteration according to the voltage error at the regulated bus. After the solution has converged the capacitor MVAR may be rounded to the nearest discrete step.

The power flow may be solved using the following iterative solution sequence:
1. Set all the bus voltages except the source bus to 1+j0
2. Set the source bus voltage to V_{source}+j0.
3. Initialize the transformer taps
4. Form the Y_{bus} matrix
5. Factorize the Y_{bus} matrix
6. Form the current injection vector [I] using the solved voltages and the designated load types to convert the P and Q values to equivalent current injections.
7. Solve V_{bus}^{t+1}=[Y]⁻¹[I^{t}]
8. Check for convergence max ∥V_{bus}^{t+1}|−|V_{bus}^{t}∥<ε
9. If converged, adjust taps, if taps changed refactorize Y_{bus}.
10. If converged, adjust capacitor settings
11. If converged and capacitors and transformer taps have been adjusted, exit.
12. Go to step 6.

Switches may be represented in the power flow solution with a low impedance branch, typically about 0.001-j0.001. The transformer loads down the MV power lines can be obtained from a number of sources such as, for example:
1. Real-time current measurements at specified locations on the feeder.
2. Interval metering data aggregated to the transformer
3. Estimated transformer loads calculated as percentage of transformer KVA rating. The loading percentage may be calculated using the utility's historic transformer load management database to calculate historic load for a given time, day of the week and month.
4. Substation feeder flows from substation interval metering or SCADA measurements where available.

The application may employ a rudimentary load allocation method to determine the transformer loads from available data. Alternately, the power flow simulator application may utilize a state estimator to solve for the network state that best fits the available measurement set.

The distribution state estimation of this example comprises a three phase state estimator. Based on n number of measurements, the state estimator estimates and/or computes other variables. In some instances, real measurements will not agree with model because a failed sensor is providing bad data. In other instances, actual measurements will not agree because they may have been obtained at different times. The state estimator is smart enough, along with enough redundancy, to know to resolve these differences and/or ignore bad data. In one embodiment, the present invention employs an Orthogonal State Estimator.

Inaccurate measurement data could prevent power flow simulation's iterative calculation from converging, i.e. power system can not be analyzed. The estimator may identify the bad measurement values by comparing measurements against the statistical data and historical data. The application may also check Q (VAR) to P (watts) scaling factor to verify that the ratio is not too large. If load power factor is not realistic then Q measurement for scaling will be ignored. Similarly if the ratio of preset load P and scaled value is too large, then P scaling will be avoided.

The power flow simulator distribution feeders typically are three phase circuits (MV power lines) which primarily serve single phase loads. This inherently creates the challenge of loading the individual phases in a balanced manner. Imbalanced loads lead to a number of significant problems including potential false tripping of a protective relay, inability to maximize utilization of system capacity and an increase in the amount of losses generated by the system. The present invention may be employed to process collected measurement data, configuration data, and simulated data to provide load balancing.

Distribution utility planners work diligently to ensure that MV power lines are balanced with the tools that they are provided. In the past, once a feeder with a load balancing issue is identified, the planner must utilize map records, customer meter consumption data, power flow models and experience to determine how to remedy the problem. The actual remedy for phase load imbalance is generally limited to two possible solutions
1. Transformers may be moved from one MV phase to another MV phase by manually relocating the MV tap connection. This typically is not done on underground feeders as the cost would be excessive and involve cutting and splicing underground cables.
2. New transformers and loads may be added in a manner to address future balancing.

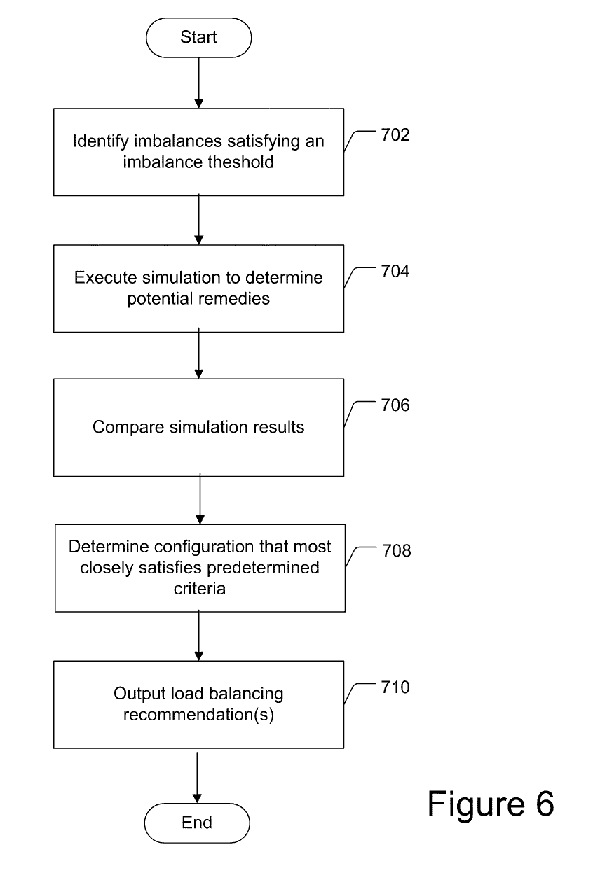

The present invention may also include a load balancing application that communicates with the power flow simulation application. Referring to FIG. 6, the load balancing application takes advantage of electric current sensing at key locations to analyze the load pattern on the MV power line (phase conductor), identifies portions of the MV power lines that are most imbalanced and uses the power flow simulation application to determine remedies to recommend. The load balancing application may access historical data (e.g., data of the most recent year) to determine average and peak loads on each MV power line (e.g., each phase) to identify imbalances that satisfy an imbalance threshold at 702. As an example, an imbalance threshold may be identified where one phase of a three phase MV power line carries fifty percent more daily average current (i.e., a fifty percent greater load) than another of the three MV phases. Additionally, the imbalance threshold may consider the available capacity for each power line. Thus, the ratio of the imbalance threshold may vary depending on the available capacity (e.g., how close a given MV phase is to being overloaded). The imbalance threshold may also factor in savings and/or the cost to determine when to provide a remedy an imbalance and to select the remedy (e.g., average cost). Load balancing may also be performed using real time data to determine the preferred configuration of one or more switches to satisfy load balancing requirements in which case the simulated data may be simulated switch configurations.

Upon determining that an imbalance has satisfied an imbalance threshold, the load balance application may actuate the power flow simulator application to process the power distribution data to identify a remedy at 704. More specifically, based on data from the load balancing application, the power flow simulator application may simulate the MV circuit with one or more distribution transformers moved from a first (more loaded) phase conductor to a second (or pair of) less loaded MV phase conductor. In other words, one or more other phases of the MV power line (or another power line) may be modeled with one or more additional transformers (i.e., the transformer(s) that may be moved from another (more loaded) MV phase conductor) and at least one more heavily loaded phase may be modeled with fewer distribution transformers (i.e., the transformers to be removed). Multiple simulations may be executed for high peak, average, and low peak loads as well for moving different sets of transformers to different power line conductors. It is worth noting that the simulated data (supplied to the power flow simulator application from the load balancing application) in this scenario may comprise data of added transformers for some power lines and the removal of data representing transformers for other power lines.

At 706, the load balancing application (or power flow simulator) may compare the data of the plurality simulations to identify a simulation that satisfies predetermined criteria (e.g., provides the lowest distribution losses) to determine the recommendations at 708. In other embodiments, the load balancing application may simply run simulations until one of the simulations provides a recommendation that satisfies a load balancing profile. The recommendations provided by the load balancing application are output at 710 and may be the configuration of the power distribution system with one or more distribution transformers to be removed from at least one power line identified and one or more distribution transformer added to be added to one or more other power lines identified. It is worth noting that the results are not limited to moving a transformer but may including moving one or more transformers among power lines and adding one or more transformers to one or more power lines. As discussed, instead of moving transformers the load balancing application may supply simulated switch configuration data to make real time determinations to immediately balance an overloaded power line or imbalanced MV circuit in which case the output recommendations may comprise switch configurations. In some circumstances, the output data may include both switch configuration data and the identify (and location) of transformers to be added and/or removed.

In each of these embodiments, the load balancing application may output data for transmission to actuate one or more switches (to change their state) to control the flow of power. Similarly, the dynamic voltage optimization application may output data for transmission to actuate one or more capacitor banks (to change their state), one or more switches (to change their state), one or more voltage regulators (to change their voltage outputs), load tap changers (to change their voltage outputs), and/or other UNE devices to regulate voltages. Similarly, the VAR application may output data for transmission to actuate one or more capacitor banks (to change their state), one or more switches (to change their state), voltage regulators, and/or load tap changers to control (reduce) VARs. In each case, the outputted data may be transmitted by one or more intermediate devices which may translate the output data to commands recognizable by the receiving devices.

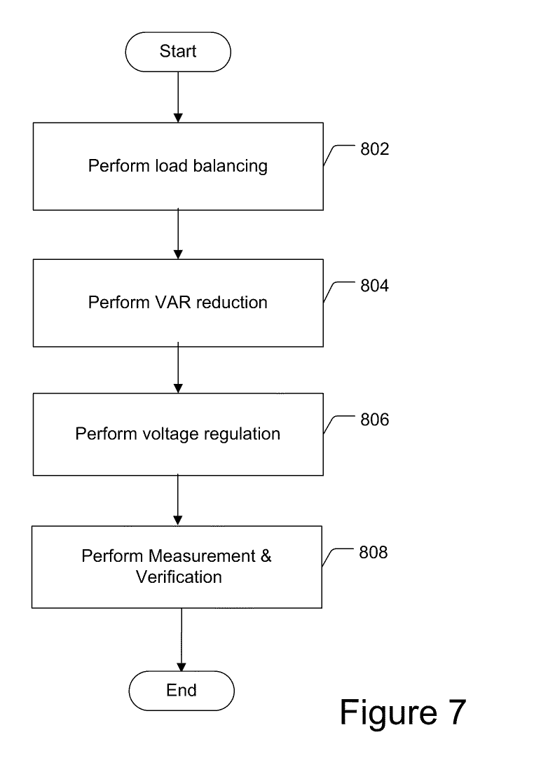

For some power distribution systems, it may be desirable to regularly execute a suite of software applications in order to manage the power distribution system to provide reliable power to customers efficiently. Referring to FIG. 7, an example process may include load balancing at 802, which may result in actuation of one or more switches. At 804, a VAR application may be executed to reduce overall power consumption by reducing VARs, which may result in the switching in or out of one or more capacitor banks. At 806, voltage regulation may be performed in order to reduce the overall power consumption, which typically includes reducing the voltage to a level slightly above regulatory requirements. For example, the dynamic voltage optimization application may cause changes in the voltage outputs of one or more voltage regulators, substation voltage control devices (e.g., load tap changers), and/or the switching in or out of one or more capacitor banks. A Measurement & Verification process may be executed at 808 to quantify and report the benefits achieved by each of these processes. Each of these processes 802, 804, 806 and 808 may require execution of the power flow simulation application and may be repeated regularly. In some embodiments, the order of these processes may be necessary and in other embodiments the order may not be important or necessary (and some processes may be performed more often than others).

Simulated data may be used by a Measurement and Verification (M&V) software application that is designed to quantify and verify the savings generated by a DVO application. An M&V application may use power flow modeling to calculate the amount of load reduction (e.g., power reduction) that is (or would be) delivered by a DVO application and create a database storing those savings on a five minute basis to be used for reporting purposes. Monetary savings may be determined by comparing measured use before and after implementation of a configuration change or models using different configurations (i.e., different simulated data).

State Estimator Overview

Previously, the downstream transformer loads were estimated from transformer ratings and or customer metering information and in many cases there was significant errors in the downstream feeder loadings so that accurate voltage and load transfer calculations were difficult. With the real-time State Estimator and an adequate measurement set, the downstream loadings can be accurately estimated, by weighting the measurements according to their accuracy so that the smoothed consistent transformer loads may be provided to perform Voltage/VAR management (and optimization) and to the DVO applications. Another important application of the State Estimator is in the validation of savings from installed Voltage/VAr control schemes, the state estimator solution can be used to provide a base case to estimate the changes in load and losses that have been achieved with the Voltage/VAr control schemes.

The State Estimator application provides the means to calculate the solved voltages and flows along the feeder for a given set of measured or estimated loads and other available measurements.

The State Estimator uses the Weighted Least Squares method where the Normal Equations are iteratively solved to find the voltages and currents which minimize the weighted sum of the squares of the errors between the estimated and measured values. The current injection formulation of these equations may be used.

Unbalanced State Estimator Model

The State Estimator Application uses the weighted least squares method to solve for the voltages and phase angles, for a given set of measurements.

The input data to the State Estimator Application is:
1. Power System bus model, usually exported from GIS, the bus model defines a set of nodes and connected devices, including:
   a. Lines
   b. Transformers
   c. Capacitors
   d. Sources
   e. Distributed generations
   f. Dispatchable loads
2. Power system component attributes.
3. Real-time voltage and current measurements from downstream measurements.
4. Real-time voltage, real-power and reactive power measurements at the substation, typically from SCADA.
5. Distributed generation MW and MVAR measurements where applicable

Output Data from the State Estimator Application may include:
1. Voltage magnitudes and angles for each bus in the model
2. Flows in amps on each segment of conductor and switch
3. A list of overloaded lines/transformers
4. Smoothed loadings for each downstream transformer

Unbalanced State Estimator Algorithm

The State Estimator is solved using the weighted least squares algorithm where the sparse unbalanced Gain matrix is used to iteratively solve for the complex bus voltages. For distribution networks it is better to use a current injection formulation for the state estimator problem as it follows very closely with the sparse Y_{bus} formulation used in the distribution power flow.

Normal Equation Method for State Estimation

In classical State Estimation, the model used to relate the measurements and the state variables is

Z=h(X)+^{N}

where:

Z=vector of measurements

X=vector of state variables

N=measurement noise

h=function relating state variables to measurements

In examples of the present invention, complex bus voltages may be used as state variables.

N is assumed to be a Gaussian distribution with zero mean and variance σ². σ² is used to weight each individual measurement. More accurate measurements will have a lower σ²', while the pseudo measurements are assigned with higher σ²'s to highlight the lower confidence given to these measurements. The noise elements are assumed to be independent. Let R be the covariance of N, then Rᵢᵢ=σᵢᵢ², the variance of the i-th measurement. Weighted Least Square (WLS) estimation computes the state variable vector X which minimizes the following function:

J(X)=0.5[Z−h(X)]^{T}R⁻¹[Z−h(X)]

J(X) is minimized by differentiating it with respect to X, and setting the resulting nonlinear equation to zero. Then the nonlinear equation may be solved iteratively by Newton's method. Let H, be the measurement Jacobian matrix at the i-th iteration, then update of the state variables can be found by solving the following equation. Equation (3) is called the normal equation of the W S problem. H^{T}R⁻¹H is called the gain matrix. A solution of [X] can be obtained by solving the equation below iteratively until the vector components of the right-hand side are sufficiently small.

[H^{T}R⁻¹H][ΔX]=[H^{T}R⁻¹ΔZ]

Current Injection Method for State Estimation

In the current based formulation, it may be assumes that all injection and flow measurements can be specified as a current flow in amps. By doing this it is possible to build a measurement Jacobian matrix and Gain matrix that is independent of the voltage state and can be built once and factorized in sparse form and used in repeat solution.

In the current formulation, the state variables are the complex node voltages V. The measurement variables are the complex current injections and flows Z. The measurement Jacobian H for a set of current injection measurements is:

HΔV=ΔZ

For a current injection measurement the Jacobian terms are:

Hᵢⱼ=Y_{bus,i,j}

As by definition I=Y_{bus} V

Therefore it can be shown that the row of the measurement Jacobian matrix is simply the row of the bus admittance matrix corresponding to the bus of the injection.

For a current flow measurement, measurement n, the Jacobian terms are formed similarly using the mutual terms of the line admittance matrix Yᵢⱼ:

Yᵢⱼ(ΔVᵢ−ΔVⱼ)=ΔIᵢⱼ=ΔZₙ

Hₙᵢ=Y_{line,i,j}

Hₙⱼ=−Y_{line,i,j}

For a voltage measurement the Jacobian term is unity:

Hₙᵢ=1.0

As ΔVᵢ=ΔZ

In all cases the Jacobian terms do not change with the state V, so the Jacobian and Gain matrix need only be calculated once in the solution process.

### Zero Injection Measurements

High confidence zero injection measurements are applied at all buses where there is not a connected source injection or load injection. Note that capacitor buses are considered zero injection buses as the impedance of the capacitor is normally embedded in the bus admittance matrix.

Measurement Mismatch Calculation

The measurements normally available in some embodiments are:
1. Source injection in kW and kVArs
2. Load pseudo measurements in kW and kVArs
3. Zero injection measurements
4. Line and transformer current magnitude measurements in amp.
5. Node voltage magnitude measurements in kV

The current injection approach requires that one develop an equivalent complex current and complex voltage for each measurement to use in the iterative solution. These complex measurement values are obtained by obtaining the phase angle from the last calculated value of the measurement:

I_{k,measured}=|Iₖ|*arg(I_{k,calculated})

Where

I_{k,measured}=equivalent measured flow

I_{k,calculated}=calculated flow

|Iₖ|=current magnitude measurement

For voltage measurements a similar calculation may be performed:

V_{k,measured}=|Vₖ|*arg(V_{k,calculated})

Where

V_{k,measured}=equivalent complex measured voltage

V_{k,calculated}=calculated node voltage

|Vₖ|=voltage magnitude measurement

For a source or load injection one may assume to have the kw and kvars so:

I_{k,measured}=V_{k,calculated}*(P_{k,measured}−jQ_{k,measured})

Where

P_{k,measured}=measured kW injection

Q_{k,measured}=measured kVAr injection

V_{k,calculated}=last calculated complex voltage

In order to get the iterative process started the Distribution Power Flow is solved using the injection measurements only; this approximate solution is used to provide the calculated values. Using these calculations, the complex measurement mismatch vector AZ is formed.

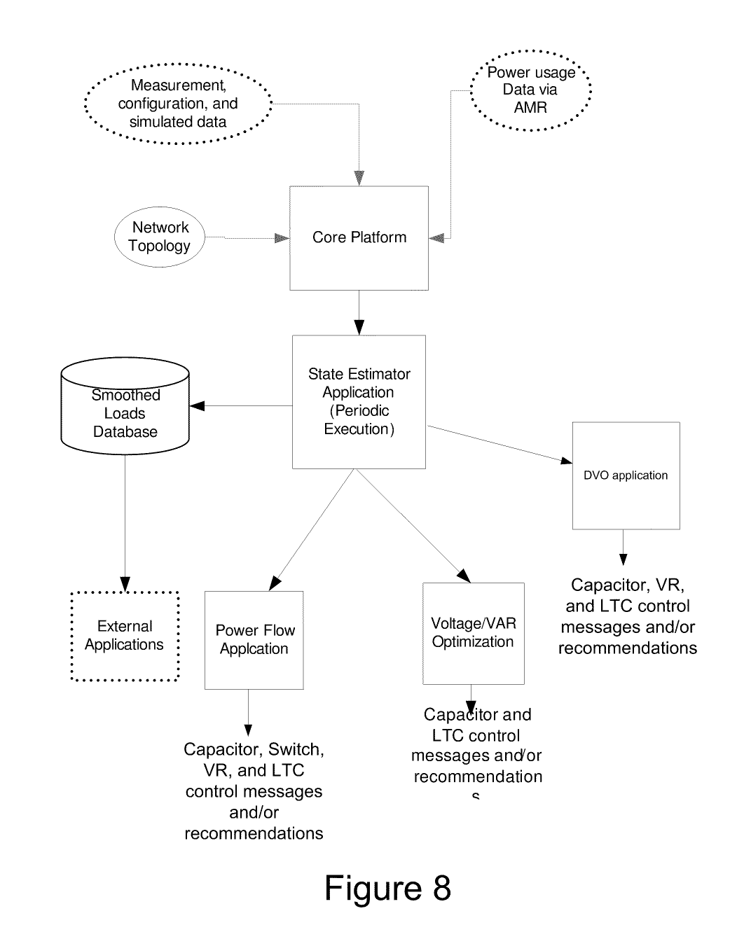

FIG. 8 schematically illustrates a plurality of applications including a core application that includes the software operating system, user interfaces, integration interfaces to other software applications (GIS, SCADA, etc.), relational database management system, software security and that may control the operation of the various other applications. The core platform (application) receives real-time (and historical) measurement data, configuration data, and simulated data. As part of such data, power usage data and network topology are specifically illustrated in the figure. Portions of the received data may be provided to the State Estimator Application periodically for processing. As discussed, among other things, the State Estimator Application may (1) identify “bad” data and either delete the data (i.e., not pass it on) or overwrite the bad data with estimated data; and (2) provide data for nodes at which no data is available.

The output data from the state estimator may be stored in a database (e.g., include “smoothed” load (power) data) and also provided to one or more applications such as the power flow application, a voltage/VAR management application, a DVO application, a predictive fault application, a fault location application, and/or other applications—and such applications process the received data and output alerts and/or control messages to change the configuration of one or more UNE devices as described herein.

Thus, one embodiment of the present invention may comprise a method of processing data of a power distribution network that includes a plurality of utility network elements comprising one or more capacitor banks, and a substation voltage regulating device, comprising obtaining actual data that comprises (a) real time measurement data of measurements of one or more parameters taken by a plurality of sensors distributed throughout the power distribution system; (b) data of a configuration of each of the one or more capacitor banks; (c) data of an output of the substation voltage regulating device; and (d) data of the interconnectivity of a multitude of the utility network elements of the power distribution system; receiving first simulated data that comprises data of a potential configuration of a first utility network element in a configuration other than the actual configuration in which the first utility network element is presently operating; processing the actual data and the first simulated data to determine a first set of output data; wherein the first set of output data includes data of a current and a voltage at a multitude of the utility network elements of the power distribution network; outputting at least some of the first set of output data. If measurement data of the one or more parameters is not available for a plurality of locations of the power distribution network, the method may further comprise estimating a value for the one or more parameters for each of a multitude of the plurality of location.

The method may further comprise receiving second simulated data that comprises data of a potential configuration of a second utility network element in a configuration other than the actual configuration in which the second utility network element is presently operating; processing the actual data and the second simulated data to determine a second set of output data; wherein the second set of output data includes data of a current and a voltage at the multitude of utility network elements; and determining whether the first set of output data or the second set of output data more closely satisfies a power distribution profile, determining that the first set of output data more closely satisfies the power distribution profile than the second set of output data; and based on said determining that the first set of output data more closely satisfies the power distribution profile than the second set of output data, transmitting a control message to the first utility network element to cause the first utility network element to transition to the potential configuration of the first simulated data. Said processing may include using a Ybus Gauss-Seidel algorithm.

In yet another embodiment the present invention may comprise a computer system for processing data of a power distribution network that includes a plurality of utility network elements, that comprises a memory storing actual data that comprises (a) measurement data of measurements of a parameter taken by a plurality of sensors distributed throughout the power distribution system; (b) configuration data that comprises data of a configuration of each of a multitude of the utility network elements; and (c) interconnectivity data that comprises data of the interconnectivity of the multitude of utility network elements of the power distribution system; a state estimator application configured to provide estimated data for the parameter at one or more locations on the power distribution network for which no measurement data is available; a power flow simulation application configured to receive an input from said state estimator application; said power flow simulation application being configured to receive first simulated data that comprises data of a first utility network element in a first configuration other than the actual configuration in which the first utility network element is presently operating; said power flow simulation application being configured to access the measurement data, the configuration data, and the interconnectivity data in the memory; said power flow simulation application being configured to process the input from the state estimator application, the measurement data, the configuration data, the interconnectivity data, and the first simulated data to output a first set of output data; and wherein the set of output data includes data of a voltage at a group of utility network elements of the power distribution network. The said state estimator application may also be configured to identify measurement data that is inaccurate.

In addition, the power flow simulation application may be configured to receive second simulated data that comprises data of a second utility network element in a second configuration other than the actual configuration in which the second utility network element is presently operating; to process the input from the state estimator application, the measurement data, the configuration data, the interconnectivity data, and the second simulated data to output a second set of output data; and wherein the second set of output data includes data of a voltage at the group of utility network elements of the power distribution network. The computer system may include a processing application configured to determine whether the first set of output data or the second set of output data more closely satisfies a power distribution profile and to output control messages to implement the associated configuration thereof.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method of processing data of a power distribution network that includes a plurality of utility network elements comprising one or more capacitor banks, and a substation voltage regulating device, comprising:
obtaining actual data that comprises:
(a) real time measurement data of measurements of one or more parameters taken by a plurality of sensors distributed throughout the power distribution system;
(b) data of a configuration of each of the one or more capacitor banks;
(c) data of an output of the substation voltage regulating device; and
(d) data of the interconnectivity of a multitude of the utility network elements of the power distribution system;
receiving first simulated data that comprises data of a potential configuration of a first utility network element in a configuration other than the actual configuration in which the first utility network element is presently operating;
processing the actual data and the first simulated data to determine a first set of output data;
wherein the first set of output data includes data of a current and a voltage at a multitude of the utility network elements of the power distribution network;
outputting at least some of the first set of output data.

2. The method according to claim 1, wherein measurement data of the one or more parameters is not available for a plurality of locations of the power distribution network, the method further comprising:
estimating a value for the one or more parameters for each of a multitude of the plurality of location.

3. The method according to claim 1, wherein the first simulated data is received from a software application configured to regulate a voltage of the power distribution network.

4. The method according to claim 1, wherein the first simulated data is received from a software application configured to reduce VARs of the power distribution network.

5. The method according to claim 1, wherein the first utility network element comprises a capacitor bank.

6. The method according to claim 1, wherein a multitude of the plurality of sensors are co-located with a multitude of electric utility meters and provide data of voltage measurements.

7. The method according to claim 1, wherein the actual data further comprises data of the configuration of one or more switches.

8. The method according to claim 7, wherein the actual data further comprises real time data of the output voltage of a voltage regulator that is located remote from the substation voltage regulating device.

9. The method according to claim 1, further comprising:
receiving second simulated data that comprises data of a potential configuration of a second utility network element in a configuration other than the actual configuration in which the second utility network element is presently operating;
processing the actual data and the second simulated data to determine a second set of output data;
wherein the second set of output data includes data of a current and a voltage at the multitude of utility network elements; and
determining whether the first set of output data or the second set of output data more closely satisfies a power distribution profile.

10. The method according to claim 10, further comprising:
determining that the first set of output data more closely satisfies the power distribution profile than the second set of output data; and
based on said determining that the first set of output data more closely satisfies the power distribution profile than the second set of output data, transmitting a control message to the first utility network element to cause the first utility network element to transition to the potential configuration of the first simulated data.

11. The method according to claim 1, wherein said processing comprises using a Ybus Gauss-Seidel algorithm.

12. A computer system for processing data of a power distribution network that includes a plurality of utility network elements, comprising:
a memory storing actual data that comprises:
(a) measurement data of measurements of a parameter taken by a plurality of sensors distributed throughout the power distribution system;
(b) configuration data that comprises data of a configuration of each of a multitude of the utility network elements; and
(c) interconnectivity data that comprises data of the interconnectivity of the multitude of utility network elements of the power distribution system;
a state estimator application configured to provide estimated data for the parameter at one or more locations on the power distribution network for which no measurement data is available;
a power flow simulation application configured to receive an input from said state estimator application;
said power flow simulation application being configured to receive first simulated data that comprises data of a first utility network element in a first configuration other than the actual configuration in which the first utility network element is presently operating;
said power flow simulation application being configured to access the measurement data, the configuration data, and the interconnectivity data in the memory;
said power flow simulation application being configured to process the input from the state estimator application, the measurement data, the configuration data, the interconnectivity data, and the first simulated data to output a first set of output data; and
wherein the set of output data includes data of a voltage at a group of utility network elements of the power distribution network.

13. The computer system of claim 12, wherein said state estimator application is configured to identify measurement data that is inaccurate.

14. The computer system of claim 12, further comprising:
said power flow simulation application being configured to receive second simulated data that comprises data of a second utility network element in a second configuration other than the actual configuration in which the second utility network element is presently operating;
said power flow simulation application being configured to process the input from the state estimator application, the measurement data, the configuration data, the interconnectivity data, and the second simulated data to output a second set of output data; and
wherein the second set of output data includes data of a voltage at the group of utility network elements of the power distribution network; and
a processing application configured to determine whether the first set of output data or the second set of output data more closely satisfies a power distribution profile.

15. The computer system of claim 14, further comprising:
a control application configured to transmit a control message to the first utility network element to cause the first utility network element to transition to the first configuration of the first simulated data in response to said processing application determining that the first set of output data more closely satisfies the power distribution profile.

16. The computer system to claim 12, wherein said power flow simulation application is configured to process at least some of the data using a Ybus Gauss-Seidel algorithm.

17. The computer system to claim 12, wherein said power flow simulation application is configured to receive simulated parameter data and to process the input from the state estimator application, the measurement data, the configuration data, the interconnectivity data, and the simulated parameter data to output a set of configuration data for one or more utility network elements; and
wherein the set of configuration data for one or more utility network elements causes a model of the power distribution system generated by the power flow application to satisfy a similarity threshold with the simulated parameter data.

18. A method processing data, implemented at least in part by a computer system, of a power distribution network having a plurality of utility network elements, comprising:
storing in a memory data of the infrastructure of the power distribution network including:
configuration data identifying a configuration of one or more switches, and
interconnectivity data identifying the interconnectivity of the utility network elements;
receiving real time data of measurements of one or more power parameters taken at a group of the utility network elements;
wherein at least one power parameter measured comprises voltage;
processing the real time data, configuration data, and interconnectivity data to provide a first model that represents a first configuration of the distribution network wherein the plurality of switches have a first configuration;
processing the real time data, state data, and interconnectivity data to provide a second model that represents a second configuration of the distribution network wherein at least one of the switches has a second state; and
determining which of the first model and the second model more closely satisfies a predetermined power distribution profile.

19. The method according to claim 18, further comprising transmitting one or more control messages to one or more network elements in order to configure the distribution network according to the second configuration.

20. The method according to claim 18, wherein the first model comprises data of estimates of one or more power parameters at a plurality of points on the distribution network.

21. The method according to claim 18, further comprising estimating a voltage at one or more location using a state estimator that processes data from a plurality of other locations.

22. A method, implemented at least in part by a computer system, of power flow analysis for a power distribution system that includes a plurality of utility network elements, comprising:
obtaining power distribution system data, comprising
(a) data of the topology of the power distribution system and
(b) data of the present operating configuration of a plurality of utility network elements;
obtaining measurement data, comprising current data and voltage data;
receiving first simulated data that comprises data of a potential configuration of a first utility network element in a configuration other than the actual configuration in which the first utility network element is presently operating;
processing the power distribution system data, the measurement data, and the first simulated data to provide a first power flow simulation that comprises first estimated data of a voltage and a current at a plurality of locations of the power distribution system; and
outputting data of the first power flow simulation.

23. The method of claim 22, further comprising comparing at least some of the first estimated data with a threshold; and
outputting a notification upon determining that the first estimated data is beyond the threshold.

24. The method of claim 22, wherein the first power flow simulation further comprises estimated data of a VARs at a plurality of locations.

25. The method according to claim 22, wherein measurement data is not available for a plurality of locations of the power distribution network, the method further comprising:
estimating a value for a voltage for each of a group of the plurality of locations at which measurement data is not available.

26. The method according to claim 22, wherein the voltage data comprises real time voltage data.

27. The method according to claim 22, further comprising:
receiving second simulated data that comprises data of a potential configuration of a second utility network element in a configuration other than the actual configuration in which the second utility network element is presently operating;
processing the power distribution system data, the measurement data, and the second simulated data to provide a second power flow simulation that comprises second estimated data of a voltage and a current at the plurality of locations of the power distribution system; and
determining that the first estimated data more closely satisfies a power distribution profile than the second estimated data.

28. The method according to claim 27, further comprising:
based on said determining that the first estimated data more closely satisfies a power distribution profile than the second estimated data, transmitting a control message to the first utility network element to cause the first utility network element to transition to the potential configuration of the first simulated data.

29. The method according to claim 22, wherein said processing comprises using a Ybus Gauss-Seidel algorithm.
